(19) United States
(12) Patent Application Publication
(10) Pub. No.: US 2007/0215434 A1
(43) Pub. Date: Sep. 20, 2007

(54) Subscription Based Shuttle Method

(76) Inventor: Barrett H. Moore, Winnetka, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/555,896

(22) Filed: Nov. 2, 2006

Related U.S. Application Data
(63) Continuation-in-part of application No. 11/384,037, filed on Mar. 17, 2006.
(63) Continuation-in-part of application No. 11/394,350, filed on Mar. 30, 2006.
(63) Continuation-in-part of application No. 11/279,333, filed on Apr. 11, 2006.
(63) Continuation-in-part of application No. 11/379,929, filed on Apr. 24, 2006.
(63) Continuation-in-part of application No. 11/381,247, filed on May 2, 2006.
(63) Continuation-in-part of application No. 11/381,257, filed on May 2, 2006.
(63) Continuation-in-part of application No. 11/381,265, filed on May 2, 2006.
(63) Continuation-in-part of application No. 11/381,277, filed on May 2, 2006.
(63) Continuation-in-part of application No. 11/383,022, filed on May 12, 2006.
(63) Continuation-in-part of application No. 11/420,594, filed on May 26, 2006.
(63) Continuation-in-part of application No. 11/421,694, filed on Jun. 1, 2006.
(63) Continuation-in-part of application No. 11/423,594, filed on Jun. 12, 2006.
(63) Continuation-in-part of application No. 11/425,043, filed on Jun. 19, 2006.
(63) Continuation-in-part of application No. 11/426,231, filed on Jun. 23, 2006.
(63) Continuation-in-part of application No. 11/456,472, filed on Jul. 10, 2006.
(63) Continuation-in-part of application No. 11/461,605, filed on Aug. 1, 2006.
(63) Continuation-in-part of application No. 11/461,624, filed on Aug. 1, 2006.
(63) Continuation-in-part of application No. 11/462,795, filed on Aug. 7, 2006.
(63) Continuation-in-part of application No. 11/462,845, filed on Aug. 7, 2006.
(63) Continuation-in-part of application No. 11/464,751, filed on Aug. 15, 2006.
(63) Continuation-in-part of application No. 11/464,764, filed on Aug. 15, 2006.
(63) Continuation-in-part of application No. 11/464,775, filed on Aug. 15, 2006.
(63) Continuation-in-part of application No. 11/464,788, filed on Aug. 15, 2006.
(63) Continuation-in-part of application No. 11/464,799, filed on Aug. 15, 2006.
(63) Continuation-in-part of application No. 11/465,063, filed on Aug. 16, 2006.
(63) Continuation-in-part of application No. 11/466,727, filed on Aug. 23, 2006.
(63) Continuation-in-part of application No. 11/466,953, filed on Aug. 24, 2006.
(63) Continuation-in-part of application No. 11/470,156, filed on Sep. 5, 2006.
(63) Continuation-in-part of application No. 11/531,651, filed on Sep. 13, 2006.
(63) Continuation-in-part of application No. 11/532,461, filed on Sep. 15, 2006.
(63) Continuation-in-part of application No. 11/535,021, filed on Sep. 25, 2006.
(63) Continuation-in-part of application No. 11/535,282, filed on Sep. 26, 2006.
(63) Continuation-in-part of application No. 11/537,469, filed on Sep. 29, 2006.
(63) Continuation-in-part of application No. 11/539,798, filed on Oct. 9, 2006.
(63) Continuation-in-part of application No. 11/539,861, filed on Oct. 9, 2006.
(63) Continuation-in-part of application No. 11/548,191, filed on Oct. 10, 2006.
(63) Continuation-in-part of application No. 11/549,874, filed on Oct. 16, 2006.
(63) Continuation-in-part of application No. 11/550,594, filed on Oct. 18, 2006.
(63) Continuation-in-part of application No. 11/551,083, filed on Oct. 19, 2006.
(63) Continuation-in-part of application No. 11/554,452, filed on Oct. 30, 2006.
(63) Continuation-in-part of application No. 11/555,589, filed on Nov. 1, 2006.
(60) Provisional application No. 60/820,628, filed on Jul. 28, 2006.
(60) Provisional application No. 60/823,806, filed on Aug. 29, 2006.
(60) Provisional application No. 60/825,524, filed on Sep. 13, 2006.
(60) Provisional application No. 60/825,976, filed on Sep. 18, 2006.
(60) Provisional application No. 60/826,491, filed on Sep. 21, 2006.
(60) Provisional application No. 60/827,591, filed on Sep. 29, 2006.
(60) Provisional application No. 60/827,820, filed on Oct. 2, 2006.
(60) Provisional application No. 60/827,828, filed on Oct. 2, 2006.
(60) Provisional application No. 60/828,341, filed on Oct. 5, 2006.
(60) Provisional application No. 60/828,342, filed on Oct. 5, 2006.
(60) Provisional application No. 60/829,447, filed on Oct. 13, 2006.
(60) Provisional application No. 60/829,779, filed on Oct. 17, 2006.
(60) Provisional application No. 60/862,398, filed on Oct. 20, 2006.
(60) Provisional application No. 60/862,718, filed on Oct. 24, 2006.
(60) Provisional application No. 60/863,469, filed on Oct. 30, 2006.
(60) Provisional application No. 60/863,481, filed on Oct. 30, 2006.

(51) Int. Cl. B65G 15/00

(52) U.S. Cl. 198/321

(57) ABSTRACT

By one approach, a method provides at least a first civil security shelter and a second civil security shelter and a conveyance. The method accepts consideration-based private civil security subscriptions from subscribers with respect to providing civilly-catastrophic event-based access to the conveyance and, if needed, shuttles at least one authorized beneficiary from the first shelter to the second shelter with the conveyance respondent to a predetermined condition. By another approach, a method provides a plurality of private civil security resources comprising, at least in part civil security provisions; civil security facilities; and civil security shuttle services. The method then provides authorized beneficiaries with consideration-based access to a conveyance to provide the shuttle services between various ones of the civil security facilities respondent to a predetermined condition.

### TECHNICAL FIELD

This invention relates generally to providing shuttle services.

### BACKGROUND

As powerful as the machinery of modern life appears, modern citizens are today perhaps more at risk of experiencing a serious disruption in their ability to prosper or even to survive en mass than is generally perceived. A serious disruption to any significant element of civilized infrastructure can produce catastrophic results for a broad swatch of a given civil community. Any number of natural and/or non-natural-caused events can significantly disrupt society's infrastructure and present a variety of differing threats and problems to the individual.

Many people believe and trust that their government (local, regional, and/or national) will provide for them in the event of such catastrophic occurrences. And, indeed, in the long view such is clearly a legitimate responsibility owed by any government to its citizens. That such is a consummation devoutly to be wished, however, does not necessarily make it so. Hurricane Katrina provided some insight into just how unprepared a series of tiered modern governmental entities may actually be to respond to even basic survival needs when a large-scale catastrophic event occurs. One may also observe that most communities simply cannot afford to staff and support a contingent capability to deal with a wide variety of likely infrequent and possibly unpredictable extreme events.

When a civilly-catastrophic event occurs, substantially sudden civil upheaval will often follow. Not only will many significant elements of society's infrastructure be seriously disrupted, but people in general are known to act in ways that are different and sometimes unexpected when faced with circumstances that threaten their well being or survival. This, coupled with the characterizing effects of the civilly-catastrophic event itself, can present an affected person with numerous challenges.

Modern governments typically do little to provide temporary shelter for their citizens in the face of many civilly-catastrophic events. On the other hand, even if governments provide temporary shelter during a catastrophic event, governments do not have the ability to quickly relocate those housed in the shelter if conditions warrant either during the catastrophic event itself or in the aftermath of such catastrophic events. As witnessed by the effects of hurricane Katrina, it may be days or even weeks before regional, local, and national governments can immobilize resources to relocate those housed in temporary shelters when needed. Infrastructure such as roads, bridges, airports, and highways may be damaged or impassable rendering the relocation of such temporarily-housed individuals impossible or time consuming at the least. As one such example, because of extensive flooding during the aftermath of hurricane Katrina, those individuals temporarily housed in the Superdome could not be reached for several days—even when conditions in the shelter warranted their relocation.

Many catastrophic events are survivable presuming one has access to suitable emergency resources, supplies, and shelter configured to withstand the event, particularly during the initial clear and present threat of the event. It is possible, of course, for individuals to provide such items in advance of any catastrophic event. Such an approach, however, presents a number of corresponding problems and issues. Attempting to take responsible actions to reasonably ensure one's own abilities in this regard can become, in and of itself, a seemingly insurmountable challenge. In addition, an individual may take the time to obtain and store emergency resources or provide a suitable shelter, but their storage site of choice or shelter may not be able to withstand the catastrophic event and/or the corresponding aftermath. As a result, the time and energy used to acquire and store emergency resources or build such a shelter would be wasted if the resources themselves, the storage site, or shelter does not withstand the event. Moreover, individuals may not have the ability to quickly relocate to another suitable shelter when conditions so warrant due to the resulting aftermath or destruction caused by the catastrophic event.

For these and other reasons, most if not all persons are typically bereft of a shelter and the ability to relocate to any shelter readily and quickly in a time of need.

### BRIEF DESCRIPTION OF THE DRAWINGS

The above needs are at least partially met through provision of a subscription based shuttle method described in the following detailed description, particularly when studied in conjunction with the drawings, wherein:

FIG. 1 comprises a flow diagram as configured in accordance with various embodiments of the invention;

FIG. 2 comprises a block diagram view as configured in accordance with various embodiments of the invention;

FIG. 3 comprises a flow diagram as configured in accordance with various embodiments of the invention;

FIG. 4 comprises a block diagram view as configured in accordance with various embodiments of the invention;

FIG. 5 comprises a block diagram view as configured in accordance with various embodiments of the invention; and

FIG. 6 comprises a flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENT

Generally speaking, pursuant to one form of these various embodiments, one provides a subscription based shuttle method including a first civil-security shelter, a second civil-security shelter, and a conveyance. Consideration-based private civil security subscriptions are then accepted from one or more subscribers with respect to providing civilly-catastrophic event-based access to the conveyance. At least one authorized beneficiary is then shuttled with the conveyance from the first shelter to the second shelter respondent to at least one predetermined condition. In another form of these various embodiments, one provides a plurality of private civil-security resources that include, at least in part, civil-security provisions, civil-security facilities, and civil-security shuttle services. Authorized beneficiaries are then provided with consideration-based access to a conveyance that provides the civil-security shuttle services between various ones of the civil security facilities respondent to at least one predetermined condition.

So configured, the subscriber or corresponding authorized beneficiaries (defined below) of such consideration-based services will have access to shelters, facilities, and conveyances to provide shuttling or relocation between such facilities or shelters in a time of need. In this manner, for example, during or within the aftermath of a civilly-catastrophic event, authorized beneficiaries will be shuttled between shelters or facilities when needed in response to any number of predetermined conditions, threats, events, or circumstances to name but a few examples. These subscription based shuttle methods ameliorate the logistical and time consuming problem of reaching, relocating, and moving between facilities or shelters when damaged or destroyed infrastructure may render such operations difficult or impossible. The authorized beneficiaries having access will be comforted that the type and quantity of facilities, shelters, and conveyances are preferably selected (and their maintenance governed) by experts and hence relieve the authorized beneficiary of responsibility in this regard. Moreover, the authorized beneficiaries having access will further be comforted that they will be relocated from the facilities or shelters when the conditions so warrant.

These steps are facilitated without dependency upon governmental oversight, participation, or control. The particular facilities, shelters, and conveyances that are provided can vary with the needs and requirements of the subscriber, the authorized beneficiaries, or other circumstances. Importantly, via these teachings an individual can take important steps to bring a considerably improved measure of security into their lives, knowing that, should a civilly-catastrophic event indeed be visited upon them, they will have extraordinary and reliable access to potentially needed shelters or facilities and the ability to relocate from the shelters or facilities if the need arises.

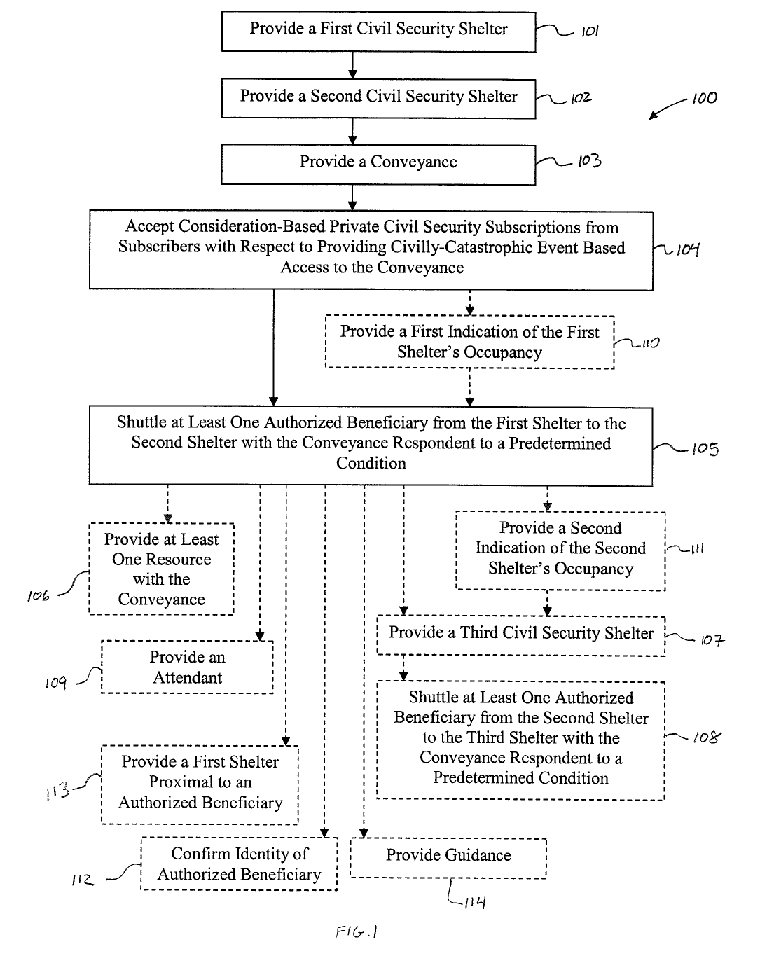

These and other benefits may become clearer upon making a thorough review and study of the following detailed description. Referring now to FIG. 1, an illustrative process 100 provides at least a first civil-security shelter 101, a second civil-security shelter 102, and a conveyance 103. Civilly-catastrophic event based access to the conveyance is provided upon accepting 104 consideration-based private civil-security subscriptions from subscribers. If the need arises, the process 100 then provides for shuttling 105 at least one authorized beneficiary from the first civil-security shelter 101 to the second-civil security shelter 102 with or though the conveyance 103 in response to at least one predetermined condition.

Accepting 104 consideration-based private civil security subscriptions from subscribers with respect to providing civilly-catastrophic event-based access to the conveyance can comprise any number of forms, types, methods, or mechanisms of subscriptions. This right of access can pertain, if desired, to a predetermined period of time. For example, a given subscription can relate to providing access to the conveyance for a one year period of time for one or more authorized beneficiaries as correspond to that subscription. By one approach, these subscriptions may be accepted by, for example, a for-profit business. By yet another approach, a not-for-profit business (such as a membership-based entity) may be the appropriate entity to offer and accept such subscriptions.

As noted above, these teachings provide for a subscription-based approach. As used herein, the term “subscription” shall be understood to refer to and encompass a variety of legal mechanisms. Some relevant examples of subscription mechanisms are provided in U.S. application Ser. No. 11/384,037, which is incorporated herein by reference in its entirety, but these teachings are not limited to the subscriptions methods provided therein or discussed below.

Some relevant examples include, but these teachings are not limited to, subscription mechanisms such as: time-limited rights of access (as where a subscription provides access rights for a specific period of time, such as one year, in exchange for a corresponding series of payments); event-limited rights of access (as where a subscription provides access rights during the life of a given subscriber based upon an up-front payment in full and where those access rights terminate upon the death of the subscriber or where, for example, a company purchases a subscription for a key employee and those corresponding rights of access terminate when and if that key employee leaves the employment of that company); inheritable rights of access (as may occur when the subscription, by its own terms and conditions, provides a right of access that extend past the death of a named subscription beneficiary and further provides for testate and/or intestate transfer to an heir); rights of access predicated upon a series of periodic payments (as where a subscription provides access rights during, for example, predetermined periods of time on a periodic basis as where a subscriber offers a payment on a month-by-month basis to gain corresponding month-by-month access rights); rights of access predicated upon a one-time payment (as may occur when a subscriber makes a single payment to obtain a time-based or event-based duration of access rights or, if desired, when a single payment serves to acquire a perpetual right of access that may be retained, transferred, inherited, or the like); ownership-based rights of access (as may occur when the subscription provides for ownership rights that pertain to a portion of the shelter); non-transferable rights of access (as may occur when the subscription, by its terms and conditions, prohibits transfer of the right of access from a first named beneficiary to another); transferable rights of access (as may occur when the subscription, by its terms and conditions, permits, conditional or unconditional transfer of the right of access from a first named beneficiary to another); membership-based rights of access (as may occur when the subscription, by its terms and conditions, establishes a membership interest with respect to the accorded right of access such as, for example, a club-based membership); fractionally-based rights of access (as may occur when the subscription, by its terms and conditions, establishes a divided or undivided co-ownership interest by and between multiple subscription beneficiaries with respect to a right to access); non-ownership-based rights of access (as may occur when the subscription, by its terms and conditions, establishes the aforementioned right of access via, for example, a lease, rental, or borrowing construct); and/or option-based rights of access. There may also be other examples of subscription types and methods.

If desired, a plurality of differentiated subscription opportunities can be offered. This plurality of differentiated subscription opportunities can correspond, for example, to providing access to differing conveyances, shelters, facilities, resources or combinations thereof. As but one very simple illustration in this regard, such subscription opportunities can differ from one another at least with respect to cost. This, in turn, provides subscriber choice with respect to selecting a particular subscription that best meets their specific needs and/or budget limitations.

These teachings also readily encompass the notion of a given subscriber providing such a subscription for an “authorized beneficiary” other than themselves. Such might occur, for example, when one family member procures such a subscription for one or more other family members. Another example would be for a company to subscribe on behalf of named key employees, family members of such key employees, and so forth. Other examples no doubt exist.

As noted, these subscriptions relate to providing access in the event of a civilly-catastrophic event. Such access may be predicated, if desired, upon a requirement that the civilly-catastrophic event be one that persists in substantial form for more than a predetermined period of time (such as one hour, one day, one week, and so forth) or that causes at least a predetermined amount or degree of infrastructure impairment or other measurable impact of choice. In addition, or in lieu thereof, such access may be predicated, if desired, upon a requirement of a particular level of objectively or subjectively ascertained likelihood that a particular category or kind of civilly-catastrophic event will occur within a particular period of time.

As used herein, “civilly-catastrophic event” will be understood to refer to an event that substantially and materially disrupts a society's local, regional, and/or national infrastructure. Such a civilly-catastrophic event can include both a precipitating event (which may occur over a relatively compressed period of time or which may draw out over an extended period of time) as well as the resultant aftermath of consequences wherein the precipitating event and/or the resultant aftermath include both the cause of the infrastructure interruption as well as the continuation of that interruption.

A civilly-catastrophic event can be occasioned by any of a wide variety of natural and/or non-naturally-caused disasters. Examples of natural disasters that are potentially capable of initiating a civilly-catastrophic event include, but are not limited to, extreme weather-related events (such as hurricanes, tsunamis, extreme droughts, widespread or unfortunately-targeted tornadoes, extreme hail or rain, and the like, flooding, and so forth), extreme geological events (such as earthquakes, volcanic activity, and so forth), extreme astronomical event (as with comets, large asteroids, and so forth), extreme environmental events (such as widespread uncontrolled fire or the like), a severe disease-based event, a severe agricultural event (such as a large scale crop failure), a severe natural shortage of a life-sustaining resource, and global or regional pandemics, to note but a few.

Examples of non-naturally-caused disasters capable of initiating a civilly-catastrophic event include both unintended events as well as intentional acts of war, terrorism, madness or the like. Examples of non-naturally-caused disasters capable of such potential scale include, but are not limited to, nuclear-related events (including uncontrolled fission or fusion releases, radiation exposure, and so forth), acts of war, the release of deadly or otherwise disruptive biological or chemical agents or creations, events that result in widespread exposure to a mutagenic danger, and so forth.

By one approach, the civilly-catastrophic event may be classified into one or more predefined categories. These categories may be based on, for example, the severity or intensity of the event, the degree of disruption to infrastructure, and/or the immediate or long term threat to human life to name but a few examples. Of course, there are other characteristics or factors that may be used to categorize such events. In a similar manner, the category of a certain civilly-catastrophic event may change as the event unfolds, and a given event may also overlap one or more categories. Furthermore, the methods herein also provide for customization of categories by particular authorized beneficiaries to meet desired conditions.

In an exemplary approach, four categories of civilly-catastrophic events are provided. It will be appreciated, however, that these categories are not intended to be all encompassing, rigid and un-flexible groupings of event types, but more generalized groupings of the catastrophic event types that can be used to provide guidance on how the shuttle services are provided to the authorized beneficiaries. For example, as further discussed in more detail below, the subscribed to shuttle service may be predicated upon a civilly-catastrophic event comprising or exceeding a certain predefined category.

By one example, a category 1 civilly-catastrophic event may comprise a relatively modest natural or non-natural event. The category 1 event may not necessarily pose a direct threat to human life if properly respected, but may be a risk to human life for those not properly prepared. The category 1 event may also be of a sufficient destructive nature to substantially and materially disrupt at least a portion of a local infrastructure. Examples of category 1 civilly-catastrophic events include, but are not limited to, a category 1-3 hurricane, an F1-F3 tornado, an earthquake of 6 or less on the Richter scale, a widespread uncontrolled fire, extreme droughts, and small tsunamis having a wave front of 5 feet or less to name but a few examples.

A category 2 civilly-catastrophic event may comprise a relatively larger natural or non-natural event. The category 2 event may present a risk to human life for those impacted by the event and/or may be of a relatively severe destructive nature to substantially and materially disrupt a local and regional infrastructure. Examples of category 2 civilly-catastrophic events include, but are not limited to, a category 4-5 hurricane, an F4-F5 tornado, an earthquake greater than 6 on the Richter scale, volcanic explosions, and large tsunamis having a wave front greater than 5 feet to name but a few examples.

A category 3 civilly-catastrophic event may comprise a severe natural or non-natural event. The category 3 event may pose an imminent risk to or may result in an immediate loss of human life in a localized area and may pose a relatively longer term threat to human life over a larger area. The category 3 type event may be of a severe destructive nature to substantially and materially disrupt a large regional infrastructure and/or may persist or result in an aftermath for an extended period of time. Examples of category 3 civilly-catastrophic events include, but are not limited to, widespread ionizing radiation exposure, detonation of a so-called dirty bomb, impacts by small comets or asteroids, regional pandemics, localized armed conflict, and terrorism to name but a few examples.

A category 4 civilly-catastrophic event may comprise a substantially extreme natural or non-natural event. The category 4 event may pose an imminent risk to or result in the immediate loss of human life on a large local, regional or national scale. The category 4 event may also be of an extreme destructive nature to substantially and materially disrupt an extended local, regional, or national infrastructure and/or may persist or result in an aftermath for an extended period of time. Examples of category 4 events include a nuclear detonation, impacts with large comets or asteroids, widespread exposure to a mutagenic dangers, severe widespread shortages of a life-sustaining resource, global pandemics, and acts of war to name but a few examples.

Referring again to FIG. 1, the process 100 includes the shuttling 105 of at least one authorized beneficiary respondent to or upon the occurrence of a predetermined condition. The predetermined condition may be a pre-defined set of conditions, may be customized by each authorized beneficiary, or may vary dependent on given circumstances. If desired, the predetermined condition can also be varied based on the particular subscription service, the individual subscribers, or the particular authorized beneficiary.

Examples of a predetermined condition may include, but are not limited to, a predetermined duration (for example, 24 hours, 48 hours, 72 hours, 1 week or less, 1 month or less, and 1 year or less to name but a few example); a predetermined shelter capacity (for example, two authorized beneficiaries in a shelter designed for two people and so forth); a predetermined interval (for example, every hour, every 2 hours, every 4 hours, every 10 hours, every 12 hours, every 20 hours, every 24 hours, every 48 hours, every week, every other week, and every month to name but a few examples); a non-predetermined interval (for example, random intervals); a shelter or facility reaching a predetermined resource level (for example, a supply of water or food being exhausted or nearly exhausted); an inability of the shelter/facility to withstand a certain threat (for example, a category 1, 2, 3, or 4 civilly-catastrophic event); a predetermined time (for example, 8 AM, 9 AM, 12 PM, 3 PM, 10 PM, 3 AM, 5 AM to name but a few examples); a predetermined day (for example, Monday, Tuesday, Wednesday, Thursday, and so forth); a certain weather condition or pattern (for example, a temperature, a pressure, a wind speed, rain, snow, to name but a few examples); a predetermined threat to one of the shelters; a communication; a signal; a location of the shelter; a terrain feature; a nature, attribute, character, or preference of an individual; a specific season (for example, winter, spring, Fall, summer to name but a few examples); a threat to the conveyance; and any combinations of the above examples.

In one particular example, it may be optimal to relocate or shuttle one or more authorized beneficiaries from a particular shelter or facility at a time less obvious to or less populated by third parties who do not have the subscribed to access or when there is less mayhem surrounding the shelter or facility. In this regard, the predetermined condition may be a time that is between midnight and prior to sunrise (such as, for example, a time between 2 AM and 4 AM) when other third parties without access may be resting, sleeping, or simply more tired due to prolonged interaction and experience with the catastrophic event. By shuttling the authorized beneficiaries at such a time, less interference by third parties would be encountered either because they may not be present or because it may be not light enough for them to observe the shuttling. However, due to the nature of the event or other circumstances, it may be warranted to relocate or shuttle the authorized beneficiaries at other times, such as a predetermined condition being between sunrise and midnight.

In another particular example, the authorized beneficiaries are relocated or shuttled from one of the shelters upon a communication or other signal. This communication or signal may, for example, be from an authorized beneficiary within a particular shelter or the communication or signal may be from a third party notifying those in a certain shelter that shuttling is warranted and imminent. The communication or signal may take many forms, such as an Internet transmission, an audible transmission, a wireless transmission, a visual transmission, a microwave transmission, a code, a radio transmission, a television transmission, a cellular transmission, a push-to-talk transmission, a digital transmission, a smoke signal, and/or a combination thereof. The communication or signal may also include, but not be limited to, a flare, beacon, tracer, flag, illumination source (such as a light emitting diode (LED)-based light, flashlight, or fire to name but a few examples), strobe, semaphore apparatus, hand signal, Morse code, sign, symbol, and/or a combination of such signals. There are, of course, other types of communications or signals.

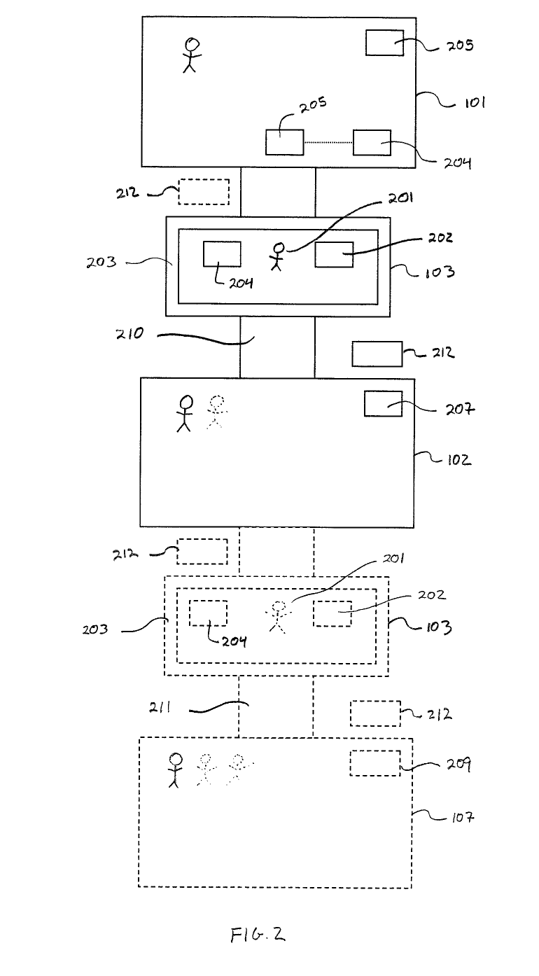

Referring to FIGS. 1 and 2, the process 100 also includes providing at least one conveyance 103 that is adapted and configured to shuttle 105 at least one authorized beneficiary between facilities or shelters. The conveyance 103 may vary depending on its eventual use, location, need, size, or ability for shuttling authorized beneficiaries from various facilities or between shelters.

For purposes herein, a “conveyance” shall be understood to include, but not be limited to, an air-borne conveyance (examples include a fixed wing aircraft, ground effects aircraft, helicopter, hovercraft, tiltrotor, lighter-than-air craft, blimp, balloon, airship, chair lift, rope, or rigging to note but a few), a terrestrial conveyance (examples include a car, sport utility vehicle, bus, truck, motorcycle, snowmobile, train, recreational vehicle, motor home, armored vehicle, tank, monorail, trailer, carriage, railcar, cart, elevator, escalator, moving walkway, or bicycle to note but a few), a water-bore conveyance (examples include a boat, ship, barge, raft, hydrofoil, submarine, hydroplane, amphibious craft, sea plane, ground effects aircraft, or personal floatation device to note but a few), a subterranean conveyance (examples include a boring machine, tunnel, cavern, cave, sink hole, subterranean fault, pipe, or conduit), a space-based conveyance (examples include a single use space craft or a reusable space craft to note but a few), a pilotless conveyance, a remotely piloted conveyance, a beast-of-burden, or a guidance between the shelters to direct authorized beneficiaries therebetween (such as a set of instructions, a path, a plurality of spaced signals (including light sources, flares, marker tags, marker objects, smoke signals, landmarks, colors, and symbols for example), a map, a verbal direction, a written direction, a visual direction, and a combination thereof to note but a few examples). Of course, the conveyance may also include any combination of the above types or examples and also may include a plurality of such conveyances types or examples. Countless other examples exist.

In many cases, the conveyance 103 will comprise a terrestrial vehicle to traverse upon the ground the distance between facilities or shelters. In such a case, it may be useful to configure and arrange the conveyance to be able to traverse off-road conditions. Such a capability may be useful, for example, to successfully move past debris, stalled, blocked, or abandoned vehicles, impassable roadways, and so forth. This can comprise configuring the conveyance with a higher-than-normal suspension, a heavy-duty suspension, all-wheel drive, and so forth. This may also comprise configuring the vehicle's engine to operate even when partially or fully submerged (as may occur when fording a flooded area). Such accoutrements are known in the art and require no further elaboration here.

In other cases, the conveyance 103 may comprise a terrestrial vehicle that has a free-ranging capability to freely navigate paved and unpaved surfaces of various kinds. In some cases, however, it may be useful to further configure and arrange the vehicle to also selectively travel compatibly on railroad tracks. This may comprise, for example, outfitting the vehicle with flanged wheels that can be selectively lowered to interact compatibly with a set of railroad tracks. Such apparatus is known in the art. So configured, the conveyance can selectively readily travel on railroad tracks which may, in a given time of need, comprise a relatively unblocked means of entering, moving within, and/or departing from a location of civil upheaval.

In many cases, as shown in FIG. 2, the conveyance 103 will be configured and arranged to shuttle human passengers 201. This may of course include both authorized beneficiaries and other individuals, such as rescue service personnel. If desired, however, the conveyance may further be configured to additionally transport a non-human cargo 202. In general, the cargo 202 may comprise any consumables, resources, or supplies to support or comfort the passengers 201 subsequent to or during the shuttle service, personal items that belong to the passengers, and so forth. Further examples are provided below—there are of course others.

By other approaches, the conveyance 103 may be a formerly operational vehicle (such as a bus, recreational vehicle, trailer, boat, or train, for example) that no longer has means for providing self-locomotion that is converted and equipped to function as the conveyance. For example, the conveyance 103 may be configured and arranged to receive propulsion, a power unit, or other powering device to thus convert the non-self-powered conveyance into a self-powered conveyance. By another approach, the conveyance 103 may be provisioned with wheels, tracks, rails, jets, floats, a hull, pontoons, propellers, skids, and so forth, to facilitate selective movement of the conveyance.

The conveyance 103 may also, for example, be towed, hoisted, lifted, or otherwise transported between shelters or facilities by another powered conveyance. This may comprise, for example, a trailer that is towed and transported by a truck, rail cars that are pulled by a train, or tracks to facilitate movement of a trailer. As yet another option, a boat or other water-borne platform may be towed or pushed by another boat or water-borne vehicle in water. The conveyance 103 may also be configured and arranged to be hoisted into the air and towed by an airborne conveyance. In this regard, the shelter itself may also comprise the conveyance, such as when the shelter is hoisted into the air by a helicopter. To this end, the conveyance 103 may also be configured to accommodate any of a variety of interfaces to facilitate the interconnection of a non-powered conveyance to a powered conveyance. For example, the conveyance may interface with the vehicle using a lift-line interface when being airlifted by an airborne conveyance. A chain or cable may be used to tow the trailer. The interface may also comprise a rope, a cradle, a hook, a magnet, or other coupling device, to name but a few examples. Various kinds of interface equipment are known in the art and any or all may be used to connect or otherwise interface a self-powered vehicle and a mobile shelter.

In some cases, the conveyance 103 may include a reinforcement 203 or other reinforcing member, structure, or arrangement. The reinforcement 203, by one approach, would enable the conveyance 103 to remain operative in the aftermath, during a civilly-catastrophic event, or otherwise provide protection from a number of threats. In general, the reinforcement 203 may include any structural reinforcement, environmental protection, or other strengthening provisions so configured to enable the conveyance 103 to remain operative and withstand the event or other potential threats. The reinforcing arrangement can include, for example, providing the conveyance with sufficient strength or other capabilities to withstand significant and/or repeated impacts with moving objects, exposure to undue heat or cold, exposure to flooding and/or immersion, looting and/or vandalism activities, exposure to caustic agents, shock waves from explosives, and so forth as desired and/or as may be appropriate to a given application setting. Such strength or capabilities may be owing, for example, to materials that are employed to construct the conveyance and/or the specifics of the design of the conveyance itself.

By one approach, the reinforcement 203 may include, but not be limited to, a positive air pressure within at least a passenger area, air tight seals, water tight seals, electromagnetic pulse shielding, armor, radiation shielding, biological agent protection, chemical agent protection, fireproof materials, waterproof materials, and/or thermal insulation to note but a few examples. Of course, the reinforcement may also include a combination of such examples.

It may be anticipated that the civilly-catastrophic event of concern may involve, at least in part, unhealthy and/or dangerous ambient airborne contaminants; therefore, in one particular example, the reinforcement 203 can comprise configuring and arranging a passenger area or other compartment of the conveyance 103 to selectively have a positive air pressure when desired to aid in urging external airborne contaminants from entering the passenger area or compartment. Examples of such contaminants include, but are not limited to, dangerous biological elements, dangerous chemical elements (including acidic gases), dangerous radioactive elements, and so forth. These examples include both man-made and natural contaminants; for example, “chemical elements” can include both a man-made nerve gas and volcanic ash. By one approach, therefore, the reinforcement 203 can comprise a passenger area or compartment that is substantially airtight. Various mechanisms are known in the art by which to provide positive air pressure in a contained space and therefore require no further detailed description here. As an alternative (or in combination with the above approaches), the passenger area can be configured to include masks, hoods, or other contrivances to facilitating delivering safe breathing gases to the passengers when the ambient environment may be dangerous to breath.

In another example, because it may be anticipated that at least some civilly-catastrophic events may be accompanied by an electromagnetic pulse, the reinforcement 203 may include protection that hardens the conveyance or at least protects the critically vulnerable systems of the conveyance to thereby substantially protect those systems against an electromagnetic pulse Such a pulse can permanently damage many electrical circuits including, for example, electronic engine controls (including but not limited to a so-called electronic control module (ECM)) for a vehicle. Again, various ways and means of achieving such a result are known in the art and may be practiced here as desired.

In yet another example, the reinforcement 203 may include a support or support members sufficient to retain the integrity of an interior space of the conveyance. In this regard, the support would be sufficient to structurally harden the conveyance in order to resist collapse or breach. Preferably, the support member would enable the conveyance, and in particular the interior space thereof, to remain accessible and operative during a civilly-catastrophic event. Examples of a suitable support are well known in the art and may include, but not be limited to, a matrix structure, framing, gussets, ribs, cross-supports, honeycomb materials, high strength metals, and/or high strength plastics, to name but a few examples.

Rather than the conveyance 103 being a powered or towed vehicle-type apparatus, by another approach, the conveyance 103 can be a mobile or static connection or link between various ones of shelters or facilities. For example, the conveyance may be a tunnel connecting the shelters. A powered conveyance may carry the authorized beneficiaries through the tunnel, or the tunnel may provide a path in which the authorized beneficiaries walk or ride a bicycle between the shelters. By another approach, the conveyance 103 may include a moving walkway, escalator, and the like to move authorized beneficiaries when they step onto the conveyance. In another example, the conveyance may be a chair-lift type apparatus in which the authorized beneficiary sits on a carriage and the chair-lift ferries the carriage between the various shelters or facilities. By yet another approach, the conveyance 103 may be an elevator that connects a shelter in the basement of a building to a shelter located on another floor, such as the roof. Countless other examples of the conveyance also exist.

As mentioned in the background, when a civilly-catastrophic event occurs, substantially sudden civil upheaval will often follow. In this situation, people in general are known to act in ways that are different and sometimes unexpected when faced with circumstances that threaten their well being or survival. This, coupled with the characterizing effects of the civilly-catastrophic event itself, can present a variety of challenges to the shuttling 105 of authorized beneficiaries in one of the above described conveyances 103.

As a result, it may also be desirable to further outfit the conveyance 103 in various other ways to better improve the prospects of the conveyance to be able to successfully carry out its shuttle services. Referring again to FIGS. 1 and 2, this outfitting can comprise providing 106 at least one resource 204 (in addition to or in lieu of the cargo 202) with, on, or included in the conveyance 103. This resource 204 may include any of a variety of items, supplies, or devices that are designed to improve the survivability of the passengers, to improve the likelihood that the conveyance can complete its designated travel, and so forth. The resource 204, of course, can be provided to facilitate or aid other circumstances as well. By one approach, the at least one resource 204 includes at least one of: supplies, equipment, and self-defensive capabilities to note but a few examples.

In one particular example, the at least one resource 204 provided with the conveyance 103 may include, but is certainly not limited to: radiation shielding; biological/chemical agent protection (including but not limited to the aforementioned positive air pressure capability, decontamination facilities, sealed compartments, and so forth); medical supplies (including but not limited to first aid supplies as well as emergency medical services or paramedic first aid equipment and supplies such as blood, plasma, automatic external defibrillators, radiation exposure treatments, chemical exposure treatments, antibiotics (including but not limited to medicines such Tamiflu and the like, and so forth)); spare conveyance parts (including but not limited to mission critical parts relating to the conveyance's drive train, propulsion system, trajectory controls, important electrical components such as, but not limited to, an electronic control module (ECM), and so forth); conveyance maintenance tools; and/or supplemental conveyance fuel supplies (carried in on-board auxiliary fuel tanks and/or non-integral fuel containers of choice).

By another approach, the resource 204 provided with the conveyance 103 may also comprise, at least in part, rescue-type supplies. The precise nature of the rescue-type supplies will, of course, vary with the application setting. An illustrative non-exhaustive listing in this regard could include: authorized beneficiary locator apparatus (such as, but not limited to, navigational devices that receive wireless updates regarding a present (or near term, such as within the past 15 minutes or so) location of a given authorized beneficiary, homing device tracking equipment, and so forth); low-light (including no-light) vision equipment (to facilitate rescue operations in vision-impaired settings); fire-fighting equipment (such as, but not limited to, fire extinguishing supplies and tools, barrier breaching equipment and tools, flame retardant garments, auxiliary breathing equipment, and so forth); climbing equipment (such as, but not limited to, rope, pitons, rappelling gear, gripping handwear and footwear and related powders and substances, pulleys, and so forth); first aid equipment (such as, but not limited to, first responder medical equipment and supplies, automatic external defibrillators, oxygen, lost blood replacements (such as blood, plasma, artificial blood, and so forth), wound dressings, stretchers and body boards, and so forth); human restraining equipment (such as, but not limited to, personal restraint devices, handcuffs, ties, and so forth) to restrain, when necessary, persons interfering with a rescue, an unduly uncooperative authorized beneficiary, and so forth; electronic navigation equipment (such as, but not limited to, global positioning system-based equipment and aids, maps (in hardcopy and or virtual form), a compass, and so forth); flotation equipment (such as, but not limited to, personal floatation equipment for rescue service personnel, authorized beneficiaries, and so forth); at least one parachute (to permit, for example, delivery of rescue service personnel, their equipment, and/or other rescue-related material); a deployable barrier (such as, but not limited to, personnel barriers (for example, barbed wire, razor wire, and so forth), vehicular barriers, and so forth); free-standing deployable emergency lights (such as, but not limited to, electrically powered lights, constantly illuminated lights, flashing lights, chemically active lights (such as flares), and so forth); whistles (such as noise makers of various kinds to aid, for example, with signaling, warning, and the like); lock-picking equipment (such as, but not limited to, tumbler pin and wafer picks, rakes and raking devices, and other lock mechanism engagement and manipulation members); two-way wireless communications equipment (such as, but not limited to, equipment using carriers of essentially any useful frequency, terrestrial and/or satellite-based infrastructure, infrastructureless platforms, and so forth); ground penetrating radar; deployable lighter-than-air vehicles configured and arranged to lift at least one authorized beneficiary (such as, but not limited to, hot air or helium balloons); extraction equipment; digging equipment; cutting equipment; vapor analyzers and related evaluation equipment; and/or explosives; to note but a few.

By yet another approach, the resource 204 provided with the conveyance 103 may include, at least in part, self-defensive capabilities such as, but not limited to, non-lethal weapons (including rubber bullet-firing weapons, electrical charge-conveying weapons, nets, concussive incapacitation devices, drug-imparting darts, tear gas, and low decibel sound generation devices to name but a few), lethal weapons (such as standard handheld and/or mounted firearms, knives, bows and arrows, crossbows and bolts, explosives, grenades, and so forth), ammunition (bullets, pellets, arrows, to provide a few examples), high-speed capabilities (such as large displacement engines, superchargers, turbochargers, jet engines, ram jets to name a few), personal armor (designed to stop at least low caliber small arms fire and offering higher ballistic protection if desired, including both bulletproof windows, bulletproof vests, louvered view ports, armored compartments, helmets, vests, gloves, boots, and so forth containing projectile resistant or projectile proof materials such as Kevlar, metal, and so forth), ramming capabilities, automatic targeting capabilities, radar, and/or acoustic devices. Of course, combinations of these examples are also possible.

By another approach, the resource 204 provided with the conveyance 103 may also include, at least in part, a plurality of life-sustaining resources as pertain to a plurality of differing categories of life's necessities (such as, but not limited to, hydration (for example, water or other beverages), nourishment, shelter, environmentally borne threat abatement, medical supplies, environmental control equipment, weapons and so forth). Such resource(s) may also comprise consumable items (including consumable necessities of human life), non-consumable items (including non-consumable necessities of human life), or both. Illustrative examples of consumable items would include, but are not limited to: food supplies, potable water, finite air supplies, batteries, hygiene supplies, sanitation supplies, and/or medical supplies, to note but a few. Illustrative examples of non-consumable items could include, but are not limited to: clothing items, personal protection items (such as face masks, gloves, foul-weather gear, and so forth), bed lines, beds, food preparation items, power generation equipment, repair and maintenance tools, evacuation tools, navigation equipment, rescue tools and supplies, communication items, and/or shelter items (such as, for example, a tent) to again note but a few.

By yet another approach, the resource 204 provided with the conveyance 103 may also include at least one non-necessity of human life. Illustrative examples in this regard might include, but are not limited to: a luxury consumable item, a luxury non-consumable item; non-human nourishment (for example, pet food); non-essential clothing; barter medium (including, for example, precious metals in a convenient barterable form); an entertainment apparatus or content; an educational tool; physical conditioning, exercise, and maintenance training and equipment; crafts supplies and training; sports equipment and facilities; and comfort foods (for example, foods and other beverages primarily consumed for enjoyment and comfort (such as a pleasing mouthfeel or satisfying organoleptic properties) rather than just for nourishment or hydration; examples include but are not limited to candies, confections, snack foods, baked goods, sugared beverages, and alcoholic beverages) to note but a few.

By yet another approach, the resource 204 provided with the conveyance 103 can optionally include a source of water or a water purification apparatus. The source of water may be provided in a water storage tank along with a suitable apparatus to provide the water to the authorized beneficiary (for example, pumps, valves, and so forth). Rather than a store of water, or in addition thereto, the water purification apparatus could be provided so that an authorized beneficiary would be able to cleanse water from an external source and render it potable. To dispense the water, the resource(s) may also include a fluid pump, such as an automatic or manual water pump or other device to transport and pressurize fluids. Water purification equipment and pumps are known in the art and require no further explanation here.

By another approach, the resource 204 provided with the conveyance 103 may also comprise medical facilities and/or any medical supplies, equipment, and implements associated therewith. For example, the conveyance may include medical materials and supplies to provide for a variety of medical emergencies or treatment of a variety of medical conditions. The resource may comprise X-ray equipment or other imaging platforms and tools, beds, various medicaments, or medical dressings to name a few. In addition, the conveyance may comprise a mobile or temporary operating or treatment room including at least some of the needed equipment, instruments, preparatory materials, and supplies to perform operations, diagnose and/or treat medical conditions, and otherwise care for patients. In this regard, an interior area of the conveyance may comprise a sterile environment or include the ability to render the interior a sterile environment when needed. Additionally, the resource may also include a medical guide, which may be written, audio, and/or visually based, to provide instruction to the authorized beneficiary regarding how to perform medical procedures or diagnose symptoms.

In another example, the resource 204 provided with the conveyance 103 may also comprise accommodations suitable for temporary occupation for one or more authorized beneficiaries. In this regard, for many application settings the resource may generally comprise simplified or limited facilities suitable for accommodating a temporary stay within the transportable container for a limited number of occupants. The simplified facilities may include, for example, one or more of: sleeping facilities, hygiene facilities, simple food preparation facilities, storage, communications facilities, and/or sanitation facilities (such as toilets, showers, disposal equipment, or other wash facilities). Other options for the resource may include, but are not limited to, auxiliary electric power supplies and sources, lighting, temperature and/or humidity control, water and/or air purification, and so forth. One particular example of a conveyance 103 including such a resource 103 is a recreational vehicle, motor home, camping trailer, and the like. Of course, other examples are also possible.

By another approach, the resource 204 provided with the conveyance 103 can include a power source (such as a generator, an inverter/battery system, and so forth). The power source could be used to provide power to any of the resource items described herein requiring power. In one form, the power source could include at least one of: a wind-based power generator (such as a windmill), a photonically-based power generator (such as a solar cell or solar array or the like), a fluid-based power generator (such as water-powered, fossil fuel-powered, or the like), a thermo-electric power generator (using, for example, steam-power, radiant heat power, a thermo-electrically active material, or the like), and/or a stored-energy source (such as a battery, fuel cell, or the like).

By yet another approach, the resource 204 provided with the conveyance 103 can also include communications equipment. This can comprise, as desired, one-way and two-way communications equipment. In this regard, if desired, the conveyance can be configured with a radio frequency antenna mast. This antenna mast can comprise a fixed-position mast or can comprise a retractable and/or otherwise extendable or movable mast that can be placed in position when needed. So configured, a wireless communications device of choice (such as, for example, a cellular telephone, transmitter, or other transmission device) can also be operably coupled thereto to thereby extend the corresponding effective communications range of the device. This can further comprise, if desired, use of signal amplifiers to increase reception and/or transmission capabilities. As further described below, the communications facilities may be employed to verify the identity of an authorized beneficiary prior to permitting the subscribed-to access to the conveyance.

Referring again to FIG. 1 and also FIG. 2, the process 100 may optionally provide a third civil-security shelter 107 and a second conveyance 103 to provide shuttle services 108 (via either the first conveyance 103 and/or the second conveyance 103) from the second shelter 102 to the third shelter 107 respondent to any one of the previously described predetermined conditions. If a second conveyance 103 is provided, it can take the form of any of the previously described conveyances provided above. Of course, the process 100 will also accommodate the provision of additional civil-security shelters and/or conveyances as needed in a given application setting.

By one approach, each civil-security shelter may be arranged and configured to provide shelter and security for at least one authorized beneficiary for a predetermined duration of time. For example, the first civil-security shelter 101 may be configured to be a short-term shelter, the second civil-security shelter 102 may be configured to be an intermediate-term shelter, and the optional, third civil-security shelter 107 may be configured to be a long-term civil security shelter. In this manner, the process 100 provides for the staging of authorized beneficiaries in various shelters in a given area as the event unfolds or during the aftermath thereof.

For example, the short-term civil security shelter may be arranged and configured to provide shelter for at least one authorized beneficiary for a first period of time, such as a few hours or a few days, during the immediate threat of the civilly-catastrophic event. The short-term shelter provides a locale for the authorized beneficiary to quickly and immediately seek protection from the event. To this end, by one approach, the short term shelter may comprise a suitable structure and include at least one resource 205 sufficient to support the at least one authorized beneficiary for the relatively short, predetermined time period in order to withstand the initial threat of the event. The resource 205 may be any of the above described resources and will not be further described here. Once the immediacy of the event has subsided or upon expiration of the first period of time, by one approach, the conveyance 103 then shuttles the authorized beneficiary from the short-term shelter to the intermediate-term shelter, which will be better equipped to support the authorized beneficiary for a longer period of time.

Emergency shelters comprise a generally well-understood area of endeavor with various construction techniques, architectural choices, and materials options being known. Generally, the first or short-term shelter (or any other shelter or facility described herein) may comprise an enclosed structure or vehicle. Such a configuration provides substantial protection for the occupants of the shelter. The shelter is generally configured and arranged to be a barrier to threat exposure created by the event. These options and configurations may vary with regard to the type of structure or vehicle that is being used as the shelter or, as further described below, the category of event the structure is designed to withstand.

Several options and configurations of the shelter are possible. If desired, the shelter can be configured and arranged to float in a liquid, such as fresh water or salt water bodies. The shelter may also be configured and arranged to be submergible. By another approach, the shelter may be substantially fireproof. The shelter may be at least partially comprised of heat resistant material to aid in preventing the interior of the shelter from becoming unsuitable for human habitation due to fire within or around the location of the shelter. If desired, the shelter may also be substantially waterproof. The shelter may be enclosed in a radiation-blocking material, such as a bladder, to provide protection to the shelter occupants from radiation exposure. The radiation-blocking material may be used in addition to or in lieu of placing the shelter underground. The radiation-blocking bladder may be at least substantially filled with liquid (such as, but not limited to, water) to comprise a radiation barrier. Alternatively (or in combination therewith), the walls, ceiling and/or floor of the shelter may incorporate, or be encased by, ionizing radiation shielding such that part, or all, of the shelter is shielded.

By another optional approach, the shelter may be armored or otherwise fortified. The armor can be designed to stop at least low caliber small arms fire and may offer higher ballistic protection if desired, including bulletproof windows, louvered view ports, and armored occupant compartments, to note but a few examples. Further, the shelter may have ports to deploy weapons. Additionally, the shelter may be otherwise structurally hardened to resist collapse or breach.

By yet another approach, the shelter may be configured and arranged to be disposed underground. An underground configuration would provide protection from a multitude of threats. Specifically, for a radioactive threat, having a considerable mass placed between the underground shelter inhabitants and the source of radioactivity would provide protection to the shelter occupants. Thus, the shelter may be covered by at least 2 meters of earth. This depth can vary, of course, with the nature of the dirt itself, as a greater depth below less dense earth may be necessary to provide a same level of radiation blockage as a lesser depth of more dense earth. By another approach, the underground shelter may comprise a subterranean shelter that can move through the earth.

As mentioned above, by one approach, after the immediacy of the threat subsides or after the expiration of the first period of time (or other predetermined condition), the conveyance 103 shuttles the at least one authorized beneficiary to the second shelter 102, which may be an intermediate-term shelter. This intermediate-term shelter is arranged and configured to provide shelter for at least one authorized beneficiary—and in particular, at least two or more authorized beneficiaries—for a second period of time that, by one approach, is longer than the first period of time. For example, the second period of time may be a few hours, a few days, a few weeks, or a few months to suggest a few examples.

The intermediate-term shelter, in many aspects, is similar to the previous described first shelter 101; however, by one approach, the intermediate-term shelter is also appropriately configured to provide protection and shelter for a relatively longer period of time and for a relatively larger number of authorized beneficiaries than the short-term shelter. To this end, the intermediate-term shelter may also optionally include at least one resource 207. As with the other shelters, the resource 207 may be similar to those previously described, and therefore, will not be further described here.

As mentioned above, by one approach, after the expiration of the second period of time (or other predetermined condition), the conveyance 103 or a second conveyance may shuttle the one or more authorized beneficiaries from the intermediate-term shelter to the optional, third shelter 107, which may be a long-term shelter. This long-term shelter is arranged and configured to provide shelter for at least one authorized beneficiary—and in particular, at least three or more authorized beneficiaries—for a third period of time that by one approach is longer than both the first and the second periods of time. For example, the third period of time may be a few hours, a few days, a few weeks, a few months, or a few years to suggest but a few examples.

The long-term shelter, in many aspects, is similar to the previous described first shelter 101 and second shelter 102; however, by one approach, the long-term shelter is also appropriately configured to provide protection and shelter for a relatively longer period of time and for a relatively larger number of authorized beneficiaries than the short-term shelter or the intermediate-term shelter. To this end, the long-term shelter may also optionally include at least one resource 209. As with the other shelters, the resource 209 may be similar to those previously described, and therefore, will not be further described here. In addition, a longer term shelter may be configured and arranged in particular ways to permit an increased degree of self-reliance with less reliance upon externally-based provisions replenishment.

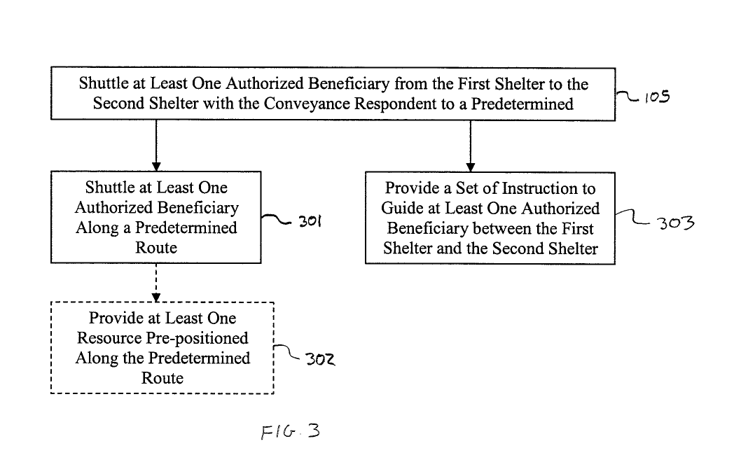

Referring to FIGS. 2 and 3, by one approach, the shuttling 105 of the at least one authorized beneficiary with or through the conveyance 103 from the first shelter 101 to the second shelter 102 (and, optionally, from the second shelter 102 to the third shelter 107 and so forth) may include shuttling 301 along a predetermined route. For instance, shuttling may be along a predetermined 210 between the first shelter 101 and the shelter 102, and/or along a predetermined route 211 from the second shelter 102 to the optional, third shelter 107 and so forth. The predetermined route 210 (or other routes) may comprise any numbers of pre-selected paths, trails, passageways, connections, links, and the like between the specific shelters or facilities. Examples include, but are not limited to, a subterranean route, an airborne route, a terrestrial route, a water route, a space-based route, and/or a combination thereof.

For example, a terrestrial route may comprise a pre-planned set of interconnecting roads, trails, paths, interstates, highways, and the like that provide a connection between the shelters. By another approach, the terrestrial route may comprise a cross-country path that does not necessarily follow existing or pre-built roadways. In another aspect, the predetermined route may comprise a subterranean connection between the shelters, such as both man-made and natural subterranean structures. Examples may be a tunnel, cave, sink hole, ground fault, subterranean fault, pipe, conduit, and a combination of such connections to provide but a few examples. On the other hand, rather than an existing or constructed subterranean connection, the conveyance 103 may also comprise a tunnel boring device that bores through the terrain in a predetermined or unplanned underground path between the various shelters or facilities.

Referring again to FIGS. 2 and 3, the predetermined route may also provide 302 at least one pre-positioned resource 212 along the route. This resource 212 may be in lieu of or in combination with the resource 204 provided with the conveyance 103. Examples of the resource 212 are provided below; there are, of course, other types of resources that could be pre-positioned along the routes.

By one approach, the pre-positioned resource 212 may include various supplies, resources, and items potentially needed during the shuttling between the various shelters or facilities. That is, for example, the resources 212 may be usable with the conveyance, for protection, for survival, or by the authorized beneficiaries or other third parties to note a few examples. If desired, the route may include a plurality of pre-positioned 212 resourced spaced therealong.

More specifically, the pre-positioned resource 212 may include, but not be limited to, a conveyance fuel supply (batteries, gasoline, diesel fuel to name but a few examples), a fuel supply storage tank (such as underground tanks, fuel bladders, above ground tanks, or 55 gallon drums to suggest a few examples) a power source, a spare part, a life-sustaining necessity, a non-necessity of human life, and/or a combination thereof.

By one approach, the power source includes at least one of: a wind-based power generator, a photonically-based power generator, a fluid-based power generator, a thermo-electric power generator, a stored-energy power generator, and/or a combination thereof. The life-sustaining necessity may comprise at least one of: breathable air, hydration, nourishment, shelter, clothing, security, medical treatment, environmentally borne threat abatement, weapons, a consumable necessity of human life, a non-consumable necessity of human life, and/or a combination thereof. The non-necessity of human life may comprise at least one of: a luxury consumable item; a luxury non-consumable item; non-human nourishment; non-essential clothing; barter medium; an entertainment apparatus; an educational tool; a comfort food item; and/or a combination thereof.

By another approach, the at least one pre-positioned resource 212 may comprise a consumable resource, such as at least one of: food supplies, potable water; finite air supplies, batteries, hygiene supplies, sanitation supplies, and/or a combination thereof. By yet another approach, the at least one resource 212 comprises a non-consumable resource, such as at least one of: clothing items, personal protection items, bed linens, beds, food preparation items, repair and maintenance equipment, evacuation tools, navigation equipment, rescue tools and supplies, shelter items, and/or a combination thereof.

If desired, the at least one pre-positioned resource 212 may be hidden, concealed, or otherwise unobvious to non-authorized beneficiaries. In this manner, the pre-positioned resource 212 will likely not be disturbed or used by those for whom it is not intended. By another approach, the pre-positioned resource 212 may be buried, mis-labeled, camouflaged, placed within an existing structure, or contained within a vehicle to provide but a few examples.

In another approach, at least a portion of an outer surface of the pre-positioned resource 212 or structure containing the resource 212 may include an indicia so that the container is highly visible. In one form, the outer surfaces may be painted a distinctive color or have easily recognizable markings (such as stripes, shapes, multi-colors) rendering the position of the pre-positioned resource 212 obvious to an authorized beneficiary. Such indicia may be advantageous in the event the resource is partially covered with debris or other materials after experiencing the civilly-catastrophic event.

Turning again to FIG. 3, the shuttling 101 of at least one authorized beneficiary may also include providing 303 a set of instructions (such as written instructions, visual instructions, verbal instruction, and a combination thereof) to guide the at least one authorized beneficiary along the predetermined routes 210 and/or 211 between the various shelters or facilities. By one approach, the authorized beneficiary is provided with a map, which may be stored in the first shelter 101, directing the authorized beneficiary along the predetermined route 210 to the position of the second shelter 102. The authorized beneficiary may then shuttle themselves from the first shelter 101 to the second shelter 102 by walking, running, riding a bicycle, riding a chairlift, using a moving walkway, driving a car or truck to suggest a few examples.

Turning back to FIG. 1 for a moment, by one approach, the process 100 may also provide 109 an attendant at the shelters (such as the first shelter 101, the second shelter 102, or the optional, third shelter 103 and so forth) or with the conveyance 103. The attendant may be a guide, an instructor, a coordinator, a medical service provider, a driver, and so forth. There are, of course, many other types of attendants.

As mentioned above, the civilly-catastrophic event may be categorized into one or more exemplary categories. By another approach, each of the shelters or facilities may be arranged and configured to withstand a certain level of catastrophic event. With this approach, the authorized beneficiary within a particular shelter would be shuttled from the currently occupied shelter when the category of the civilly-catastrophic event is one that the particular shelter is not designed to withstand. In other words, the predetermined condition trigging the shutting of authorized beneficiaries from the first shelter to the second shelter, for example, is a civilly-catastrophic event (or a genuine threat of such an event) exceeding an ability of the shelter to withstand such event. As a result, the authorized beneficiary would be relocated to another shelter that is better equipped to withstand the intensity (as defined by the category level) of the particular catastrophic event (or threat of such an event).

In one particular approach, the first shelter 101 is arranged and configured to withstand a civilly-catastrophic event of a first category (such as, for example, a category 1 event); and the second shelter 102 is arranged and configured to withstand a civilly-catastrophic even of a second category having a greater intensity than the first category (such as, for example, a category 2 or greater event). If a third shelter 107 is provided, then the third shelter 107 could be arranged and configured to withstand a civilly-catastrophic event of a third category having a greater intensity than the second category (such as, for example a category 3 or greater event.) If additional shelters are provided, they may be able to withstand certain categories of events in a like manner. By this approach, authorized beneficiaries in a particular shelter (for example, a category 1 rated shelter), therefore, would be shuttled to another higher-rated shelter (for example, a category 2 rated shelter) upon the one they are currently using not able to withstand the category level of the event (or the threatened event).

Turning back to FIG. 1, the process 100 may optionally include providing an indication of a shelter's occupancy by at least one authorized beneficiary. This indication may comprise, for example, providing 110 a first indication of the first shelter's occupancy and/or providing 111 a second indication of the second shelter's occupancy and so forth. These indications provide notification to a third party that a certain shelter is occupied and that relocation or shuttling upon the predetermined condition may be warranted at some point in the future.

By one approach, the indication may include at least one of: an Internet transmission, an audible transmission, a wireless transmission, a visual transmission, a microwave transmission, code, a radio transmission, a television transmission, a cellular transmission, a digital transmission, a flare, a smoke signal, a beacon, a tracer, a flag, an illumination source, a strobe, a sign, a signal, and a combination thereof.

By another approach, the indication may beautomatically provided or may be manually provided. For example, as illustrated in FIG. 2, the shelter may include a sensing device 204 configured and arranged to sense the presence of an authorized beneficiary therein and a signal device 205 in communication with the sensing device to automatically provide the appropriate indication. Alternatively, the shelter may also include a set of instructions to guide the authorized beneficiary in manually trigging the indication.

Again referring to FIG. 1, the process 100 may also include confirming 112 an identity of an authorized beneficiary. This confirmation may comprise, for example, confirming the identity of an authorized beneficiary prior to providing access to a shelter, facility, and/or a conveyance. To this end, the shelters, facilities, or conveyance may also include a locking mechanism that does not permit access until the identity is confirmed.

The identity of the authorized beneficiary may be confirmed through any number of mechanisms. For example, identity confirmation may comprise, if desired, use of a mechanism that the authorized beneficiary carries with them to confirm their authorized status in this regard. The identify of the authorized beneficiary may be confirmed through the use of personal property (such as an identification card, a still image, an admission card) or through, for example, a biometric-based identity authentication process that relies upon fingerprints or other asperity-based features, retinal patterns, voice prints, or some other relatively unique aspect of the human body or condition. In addition, the authorized beneficiary's identity may be confirmed through the use of a visual confirmation, a password, a pass code, a word code, or other authorization code.

By one approach, the pass code, the password, the word code, or other authorization code may be provided to an authorized beneficiary through a transmission, which can be coded, scrambled, or encrypted if desired, including at least one of: an Internet transmission, a wireless transmission, a radio transmission, a television transmission, an audible transmission, a visual transmission, a microwave transmission, a cellular transmission, a digital transmission. For example, the transmission may be provided through the mechanisms described in related U.S. application Ser. Nos. 11/426,231 or 11/461,605, both of which are incorporated herein in their entirety. Information needed to confirm identities or access certain conveyances, shelters, and or facilities may also be provided as described in related U.S. application Ser. No. 11/461,624, which is also incorporated herein in its entirety.

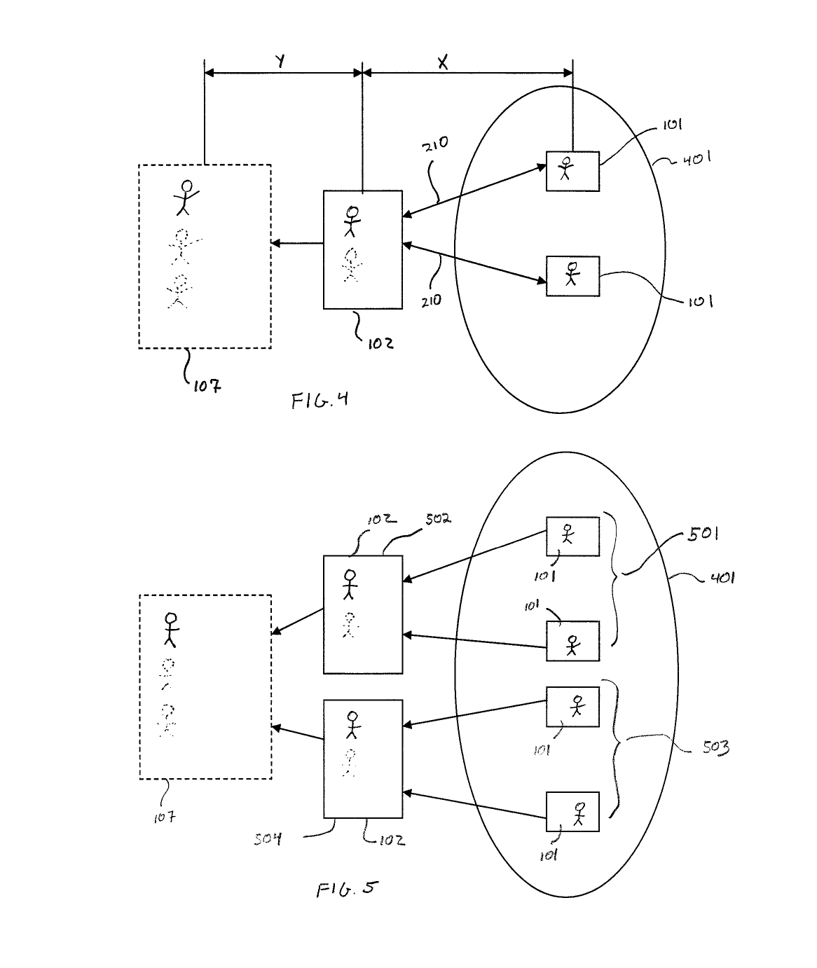

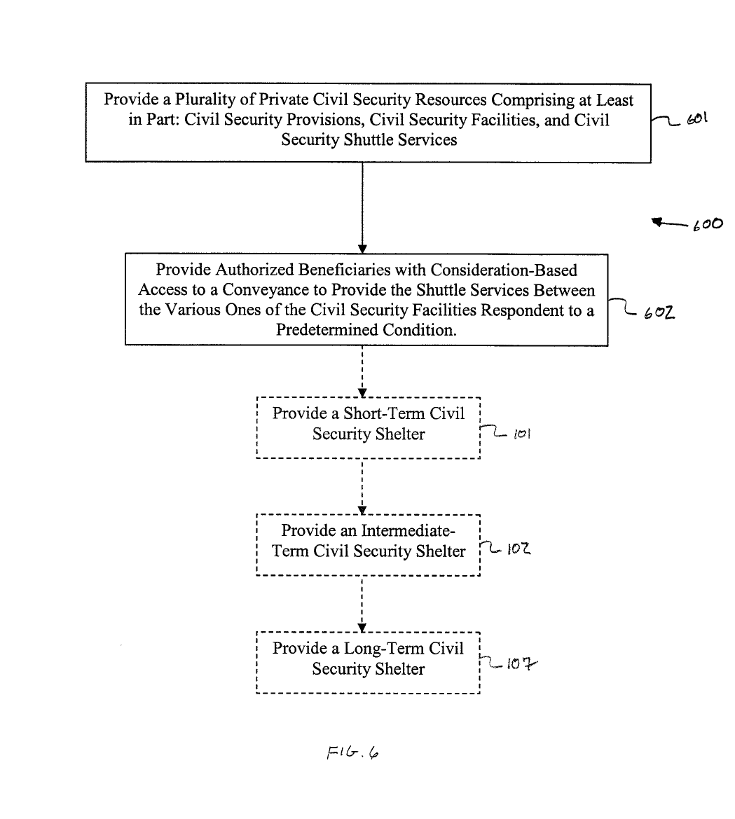

Turning to FIGS. 4 and 5, exemplary locations of the various shelters or facilities are illustrated—there, of course, will be other strategies to position such items. By one approach, the first shelter 101 is provided in a metropolitan area 401, such as within a populated city, town, or the like. If desired, a plurality of first shelters 101 may provided in the metropolitan area 401, such as every few blocks, every other building, or every few miles, to suggest but a few examples. Each of these first shelters 101 may be positioned a predetermined distance X from the second shelter 102 with a predetermined route 210 from each of the first shelters 101 to the second shelter 102. In this regard, the plurality of first shelters 101 may be spread throughout the metropolitan area 401 so as to provide 113 (FIG. 1) at least one first shelter 101 proximal to an authorized beneficiary. With a plurality of spaced first shelters, the authorized beneficiary will be comforted that that they would likely have access to a first shelter if needed even if they are mobile within the metropolitan area. Rather than positioning the first shelters 101 in a metropolitan area, the shelter could be provided 113 proximal to an authorized beneficiaries home, residence, or other dwelling structure. By one approach, the first shelter 101 is within walking distance from at least one authorized beneficiary. Of course, the shelters are not limited to use in metropolitan areas. The methods herein readily provide for the use of such shelters and facilities outside of such areas, for example, in rural or semi-rural areas.

In another approach, the second shelter 102 is spaced from the first shelter 101 by the predetermined distance X, and may also be spaced from the metropolitan area 401 containing the first shelter 101, such as in a suburb or outer ring community. By one approach, the second shelter 102 may be ½, 1, 5, 10, 20, or more miles from the first shelter 101 to suggest but a few examples. As mentioned above, while the first shelter 101 provides for at least one authorized beneficiary, the second shelter 102 can be configured to provide for at least two or more authorized beneficiaries (and the optional, third shelter 107 can provide for at least three or more beneficiaries, and so forth). As a result, the shuttling may relocate one or more authorized beneficiaries from each of the plurality of first shelters 101 into a single, second shelter 102 as shown in FIG. 4.

By an alternative approach, as shown in FIG. 5, the plurality of first shelters 101 may be provided in the metropolitan area 401, but two spaced second shelters 102 may also be provided. In this approach, authorized beneficiaries from certain first shelters 101, such as a first grouping 501, would be shuttled to a first, second shelter 502, and authorized beneficiaries from other first shelters 101, such as a second grouping 503, would be shuttled to a second, second shelter 504. If a third shelter 107 is provided, then the conveyance 103 or another conveyance may also provide shuttle service from each of the second shelters 502 and 504 to the third shelter 107 if conditions so warrant. The third shelter 107 is also a predetermined distance Y from the second shelter. By one approach, the distance Y is 5, 10, 20, or 100 or more miles from the second shelter 102 to suggest but a few examples.

The first shelters 101 may be positioned in the metropolitan areas or proximal to an authorized beneficiary in a variety of methods; some examples are provided below, there are of course others. By one approach, the shelter could be transported to and used in conjunction with an underground parking facility to thereby permit the shelter to become, in effect, an underground shelter. One or more parking spots may be reserved or rented within the parking facility for the shelter. The shelter may then be transported to the parking facility and positioned there on either a temporary or permanent basis.

Alternatively, the shelter may comprise an above ground, elevated shelter. The above ground shelter may be located on land or an upper floor of a structure, such as, for example, a building. Again, the above ground shelter may be created by customizing an existing space or may be created by constructing a new space for the shelter. By one optional approach, the building may comprise an above ground parking facility. Similarly to the underground parking facility, one or more parking spots may be reserved within the parking facility for the shelter. It may be desirable to position the shelters on a top floor or roof of the parking facility or other building such that a conveyance, such as a helicopter or other air vehicle, may lift the shelter from the top floor or roof and transport the shelter to the second shelter.

By another approach, the process 100 also optionally provides guidance 114 to the shelters for the authorized beneficiary. In one form, the guidance may include providing the location of one or more first shelters 101. Such guidance will provide to the authorized beneficiary directions or coordinates of or to the first shelter.

By one approach, the guidance 114 may include the shelters having a locating signal (such as a flare, beacon, tracer, flag, illumination source, an Internet transmission, an audible transmission, a wireless transmission, a visual transmission, a microwave transmission, code, strobe, a radio transmission, a television transmission, a cellular transmission, a digital transmission, and/or combinations thereof to name but a few types of signals) that helps an authorized beneficiary or other authorized personnel locate the shelter.

By another approach, the guidance 114 may be directions to the shelter provided through at least one of globally positioning system (GPS) coordinates, an Internet communication or broadcast, a verbal communication, a written communication, a wireless communication, a visual communication and/or combinations thereof to name a few examples. Of course, there may be other methods to provide such guidance. For example, the written communication may include the use of guide books, maps, or written directions to the predetermined locations. The visual communication may include at least one of a beacon, flare, strobe, illumination device, a flag, a symbol, or a code (such as a color code or alphanumeric code). The wireless communication may include at least one of a radio transmission, a television transmission, a cellular transmission, a digital transmission, an electronic transponder signal, and/or a beacon signal.

Turning to FIG. 6, an alternative process 600 is illustrated for providing 601 a plurality of private civil security resources. In this process, the private civil security resources may include, at least in part, civil security provisions, civil facilities, and civil security services, such as a civil security shuttle services. Authorized beneficiaries are then provided 602 with consideration-based access to at least one conveyance to provide the shuttle services between various ones of the civil security facilities respondent to a predetermined condition. In the method 600, the various provisions (such as cargo, resources, supplies, shelters and so forth), facilities (such as the first shelter, second shelter, third shelter, short-them shelter, intermediate-term shelter, and long-term shelter to name but a few example), and one or more conveyances may be similar to those previously described, and therefore, will not be further described with this method.

So configured and arranged, the shelters, facilities, resources, conveyances, and shuttle services may be helpful or even critical to easing the plight or survival of authorized beneficiaries affected by a given civilly-catastrophic event. This, in turn, can greatly increase the tangible degree of civil security perceived and experienced by such persons. These teachings will readily accommodate a variety of approaches in this regard and these solutions are readily scalable to accommodate everything from relatively modest efforts to large scale prepatory activities.

Those skilled in the art will recognize that a wide variety of modifications, alterations, and combinations can be made with respect to the above described embodiments without departing from the spirit and scope of the embodiments described herein, and that such modifications, alterations, and combinations are to be viewed as being within the ambit of the embodied concepts.

What is claimed is:

1. A method comprising:
providing a first civil security shelter and a second civil security shelter;
providing a conveyance;
accepting consideration-based private civil security subscriptions from subscribers with respect to providing civilly-catastrophic event-based access to the conveyance; and
shuttling at least one authorized beneficiary from the first shelter to the second shelter with the conveyance respondent to a predetermined condition.

2. The method of claim 1, wherein the predetermined condition comprises at least one of: a predetermined duration; a predetermined shelter capacity; a predetermined interval; a non-predetermined interval; a predetermined shelter resource level; an inability of the shelter to withstand a threat; a predetermined time; a predetermined day; a weather condition; a threat to one of the shelters; a communication; a signal; a location of the shelter; a terrain feature; of one a nature, attribute, character, and preference of an individual; a season; a threat to the conveyance; and a combination thereof.

3. The method of claim 2, wherein the predetermined duration comprises one of: less than 24 hours, less than 1 week, less than 1 month, and less than 1 year.

4. The method of claim 2, wherein the predetermined time comprises a time between midnight and prior to sunrise.

5. The method of claim 4, wherein the predetermined time comprises a time between 2 AM and 4 PM.

6. The method of claim 2, wherein the predetermined time comprises a time between sunrise to midnight.

7. The method of claim 2, wherein the predetermined interval comprises at least one of: 1 hour, 2 hours, 4, hours, 10 hours, 20 hours, 24 hours, 48 hours, and a combination thereof.

8. The method of claim 2, wherein the communication comprises at least one of: an Internet transmission, an audible transmission, a wireless transmission, a visual transmission, a microwave transmission, a code, a radio transmission, a television transmission, a cellular transmission, a push-to-talk transmission, a digital transmission, a smoke signal, and a combination thereof.

9. The method of claim 2, wherein the signal comprises at least one of a: flare, beacon, tracer, flag, illumination source, strobe, hand signal, Morse code, sign, symbol, and a combination thereof.

10. The method of claim 1, wherein providing a conveyance comprises providing at least one of: an air-borne conveyance, a terrestrial conveyance, a water-bore conveyance, a subterranean conveyance, a space-based conveyance, a pilotless conveyance, a remotely piloted conveyance, a beast-of-burden, a guidance between the shelters, and a combination thereof.

11. The method of claim 10, wherein the air-borne conveyance comprises at least one of a: fixed wing aircraft, ground effects aircraft, helicopter, hovercraft, tiltrotor, lighter-than-air craft, blimp, balloon, airship, chair lift, rope, rigging, and a combination thereof.

12. The method of claim 10, wherein the terrestrial conveyance comprises at least one of a: car, sport utility vehicle, bus, truck, motorcycle, snowmobile, train, recreational vehicle, motor home, armored vehicle, tank, monorail, trailer, carriage, railcar, cart, elevator, escalator, moving walkway, bicycle, and a combination thereof.

13. The method of claim 10, wherein the water-borne conveyance comprises at least one of a: boat, ship, barge, raft, hydrofoil, submarine, hydroplane, amphibious craft, sea plane, ground effects aircraft, personal floatation device, and a combination thereof.

14. The method of claim 10, wherein the subterranean conveyance comprises at least one of a: boring machine, tunnel, cavern, cave, sink hole, subterranean fault, pipe, conduit, and a combination thereof.

15. The method of claim 10, wherein the space-based conveyance comprises at least one of a: single use space craft, reusable space craft, and a combination thereof.

16. The method of claim 10, wherein the guidance between the shelters comprises at least one of: a set of instructions, a path, a plurality of spaced signals, a map, a verbal direction, a written direction, a visual direction, and a combination thereof.

17. The method of claim 1, wherein providing a conveyance comprises providing a conveyance having at least one reinforcement arrangement.

18. The method of claim 17, wherein the reinforcement arrangement comprises at least one of: positive air pressure within at least a passenger area, air tight seals, water tight seals, electromagnetic pulse shielding, armor, radiation shielding, biological agent protection, chemical agent protection, fireproof materials, waterproof materials, thermal insulation, and a combination thereof.

19. The method of claim 1, wherein providing a conveyance comprises providing a conveyance having self-defense capabilities.

20. The method of claim 19, wherein the self-defense capabilities includes at least one of: non-lethal weapons, lethal weapons, ammunition, high-speed capabilities, personal armor, ramming capabilities, automatic targeting capabilities, radar, acoustic device, and a combination thereof.

21. The method of claim 1, wherein providing a conveyance comprises providing a conveyance having at least one resource.

22. The method of claim 21, wherein the at least one resource comprises at least one of: authorized beneficiary locator apparatus, low-light vision equipment, fire-fighting equipment, climbing equipment, first aid equipment, paramedic first aid equipment, human restraining equipment, electronic navigation equipment, flotation equipment, at least one parachute, a human barrier, free-standing deployable emergency lights, whistles, lock-picking equipment, communications equipment, radar, a deployable lighter-than-air conveyance configured and arranged to lift at least one authorized beneficiary, extraction equipment, digging equipment, cutting equipment, explosives, fuel, spare parts, forward looking infrared radar, and a combination thereof.

23. The method of claim 21, wherein the at least one resource comprises at least one of a life-sustaining resource, a non-necessity of human life, and a combination thereof.

24. The method of claim 23, wherein the life-sustaining resource comprises at least one of: breathable air, hydration, nourishment, shelter, protective clothing, security, medical treatment, environmentally borne threat abatement, weapons, a consumable necessity of human life, a non-consumable necessity of human life, and a combination thereof.

25. The method of claim 23, wherein the non-necessity of human life comprises at least one of: a luxury consumable item; a luxury non-consumable item; non-human nourishment; non-essential clothing; barter medium; an entertainment apparatus; an educational tool; a comfort food item; and a combination thereof.

26. The method of claim 21, wherein the at least one resource comprises a consumable resource including at least one of: food supplies, potable water; finite air supplies, batteries, hygiene supplies, sanitation supplies, and a combination thereof.

27. The method of claim 21, wherein the at least one resource comprises a non-consumable resource including at least one of: clothing items, personal protection items, bed linens, beds, food preparation items, repair and maintenance equipment, evacuation tools, navigation equipment, rescue tools and supplies, shelter items, and a combination thereof.

28. The method of claim 1, wherein providing a first civil security shelter and a second civil security shelter comprises providing:
a short-term civil security shelter arranged and configured to provide shelter for at least one authorized beneficiary for a first period of time;
an intermediate-term civil security shelter arranged and configured to provide shelter for at least one authorized beneficiary for a second period of time longer than the first period of time; and
a long-term civil security shelter arranged and configured to provide shelter for at least one authorized beneficiary for a third period of time longer than both the first and second periods of time.

29. The method of claim 28, wherein the conveyance shuttles the at least one authorized beneficiary from the short-term shelter to the intermediate-term shelter as a function, at least in part, of expiration of the first period of time.

30. The method of claim 29, further comprising providing a plurality of short-term shelters and a plurality of conveyances, and wherein one of the plurality of conveyances shuttles at least one authorized beneficiary from each of the plurality of short-term shelters to the intermediate-term shelter.

31. The method of claim 28, wherein the conveyance shuttles the at least one authorized beneficiary from the intermediate-term shelter to the long-term shelter as a function, at least in part, of expiration of the second period of time.

32. The method of claim 31, further comprising providing a plurality of intermediate-term shelters and a plurality of conveyances, and wherein one of the plurality of conveyances shuttles at least one authorized beneficiary from each of the plurality of intermediate-term shelters to the long-term shelter.

33. The method of claim 28, wherein the short-term shelter is arranged and configured to provide shelter for at least one authorized beneficiary, the intermediate-term shelter is arranged and configured to provide shelter for at least two authorized beneficiaries, and the long-term shelter is arranged and configured to provide shelter for at least three authorized beneficiaries.

34. The method of claim 28, wherein the short-term shelter is within a metropolitan area.

35. The method of claim 34, further comprising a plurality of short-term shelters within the metropolitan area.

36. The method of claim 34, wherein the intermediate-term shelter is spaced a predetermined distance from the short-term shelter.

37. The method of claim 1, wherein the first civil security shelter is arranged and configured to withstand a civilly-catastrophic event of a first category and the second civil security shelter is arranged and configured to withstand a civilly-catastrophic event of a second category having a greater intensity than the first category.

38. The method of claim 37, wherein the conveyance shuttles at least one authorized beneficiary from the first shelter to the second shelter as a function, at least in part, of the civilly-catastrophic event exceeding an ability of the first shelter to withstand the intensity thereof.

39. The method of claim 37, wherein the first shelter is arranged and configured to provide shelter for at least one authorized beneficiary and the second shelter is arranged and configured to provide shelter for at least two authorized beneficiaries.

40. The method of claim 37, further comprising providing a plurality of first shelters and a plurality of conveyances, and wherein one of the conveyances shuttles at least one authorized beneficiary from each of the plurality of first shelters to the second shelter.

41. The method of claim 37, further comprising at least one third civil security shelter arranged and configured to withstand a civilly-catastrophic event of a third category having an intensity greater than the second category.

42. The method of claim 41, wherein the conveyance shuttles at least one authorized beneficiary from the second shelter to the third shelter as a function, at least in part, of the civilly-catastrophic event exceeding an ability of the second shelter to withstand the intensity thereof.

43. The method of claim 42, further comprising providing a plurality of second shelters and a plurality of conveyances, and wherein one of the conveyances shuttles at least one authorized beneficiary from each of the plurality of second shelters to the third shelter.

44. The method of claim 37, wherein the first shelter is within a metropolitan area.

45. The method of claim 44, further comprising a plurality of first shelters within the metropolitan area.

46. The method of claim 44, wherein the second shelter is spaced a predetermined distance from the first shelter.

47. The method of claim 46, further comprising at least one third civil security shelter arranged and configured to withstand a civilly-catastrophic event of a third category having an intensity greater than both the first category and the second category and wherein the third civil security shelter is spaced a predetermined distance from the second shelter.

48. The method of claim 1, wherein providing a first civil security shelter comprises providing at least one first civil security shelter having an attendant.

49. The method of claim 1, wherein providing a second civil security shelter comprises providing at least one second civil security shelter having an attendant.

50. The method of claim 1, wherein providing a first civil security shelter comprises providing at least one first civil security shelter proximal to an authorized beneficiary.

51. The method of claim 1, wherein shuttling at least one authorized beneficiary from the first shelter to the second shelter comprises shuttling an authorized beneficiary along a predetermined route between the first shelter and the second shelter.

52. The method of claim 51, wherein the predetermined route comprises at least one of: a subterranean route, an airborne route, a terrestrial route, a water route, a space-based route, and a combination thereof.

53. The method of claim 52, wherein the first shelter and the second shelter are joined by a subterranean connection.

54. The method of claim 53, wherein the subterranean connection comprises one of: tunnel, cave, sink hole, ground fault, subterranean fault, pipe, conduit, and a combination thereof.

55. The method of claim 51, wherein the predetermined route comprises at least one resource pre-positioned therealong.

56. The method of claim 55, wherein the at least one resource positioned therealong comprises at least one of: a conveyance fuel supply, a power source, a spare part, a life-sustaining necessity, a non-necessity of human life, and a combination thereof.

57. The method of claim 56, wherein the power source includes at least one of: a wind-based power generator, a photonically-based power generator, a fluid-based power generator, a thermo-electric power generator, a stored-energy power generator, and a combination thereof.

58. The method of claim 56, wherein the life-sustaining necessity comprises at least one: breathable air, hydration, nourishment, shelter, clothing, security, medical treatment, environmentally borne threat abatement, weapons, a consumable necessity of human life, a non-consumable necessity of human life, and a combination thereof.

59. The method of claim 55, wherein the non-necessity of human life comprises at least one of: a luxury consumable item; a luxury non-consumable item; non-human nourishment; non-essential clothing; barter medium; an entertainment apparatus; an educational tool; a comfort food item; and a combination thereof.

60. The method of claim 55, wherein the at least one resource positioned therealong comprises a consumable resource including at least one of: food supplies, potable water; finite air supplies, batteries, hygiene supplies, sanitation supplies, and a combination thereof.

61. The method of claim 55, wherein the at least one resource positioned therealong comprises a non-consumable resource including at least one of: clothing items, personal protection items, bed linens, beds, food preparation items, repair and maintenance equipment, evacuation tools, navigation equipment, rescue tools and supplies, shelter items, and a combination thereof.

62. The method of claim 55, wherein the at least one resource positioned therealong is concealed.

63. The method of claim 1, wherein shuttling at least one authorized beneficiary from the first shelter to the second shelter comprises an authorized beneficiary following a set of instructions to guide the at least one authorized beneficiary along a predetermined route between the first shelter and the second shelter.

64. The method of claim 63, wherein the instructions comprise at least one of: written instructions, visual instructions, verbal instructions, and a combination thereof.

65. The method of claim 1, further comprising providing a first indication of the first shelter's occupancy by at least one authorized beneficiary.

66. The method of claim 65, further comprising providing a second indication of the second shelter's occupancy by at least one authorized beneficiary.

67. The method of claim 66, wherein one of the first indication and the second indication is at least one of: an Internet transmission, an audible transmission, a wireless transmission, a visual transmission, a microwave transmission, code, a radio transmission, a television transmission, a cellular transmission, a digital transmission, a flare, a smoke signal, a beacon, a tracer, a flag, an illumination source, a strobe, a sign, a symbol, and a combination thereof.

68. The method of claim 65, wherein providing a first indication of the first shelter's occupancy comprises automatically providing the first indication of the first shelter's occupancy upon access by an authorized beneficiary.

69. The method of claim 68, wherein the first shelter comprises a sensing device configured and arranged to sense the presence of an authorized beneficiary within the first shelter and a signal device in communication with the sensing device to automatically signal the sensed presence of an authorized beneficiary.

70. The method of claim 65, wherein providing a first indication of the first shelter's occupancy comprises an authorized beneficiary manually providing the first indication.

71. The method of claim 66, wherein providing a second indication of the second shelter's occupancy comprises automatically providing the second indication of the second shelter's occupancy upon access by an authorized beneficiary.

72. The method of claim 71, wherein the second shelter comprises a sensing device configured and arranged to sense the presence of an authorized beneficiary within the second shelter and a signal device in communication with the sensing device to automatically signal the sensed presence of an authorized beneficiary.

73. The method of claim 66, wherein providing a second indication of the second shelter's occupancy comprises an authorized beneficiary manually providing the second indication.

74. The method of claim 1, further comprising confirming an identity of an authorized beneficiary.

75. The method of claim 74, wherein the identity is confirmed prior to providing access to the first shelter.

76. The method of claim 74, wherein the identity is confirmed prior to providing access to the second shelter.

77. The method of claim 74, wherein the identity is confirmed prior to providing access to the conveyance.

78. The method of claim 74, wherein the identity of the authorized beneficiary is confirmed by at least one of: biometrics; an identification card; a still image; a visual confirmation; an admission card; a password; a pass code; a voice print; words; and a combination thereof.

79. The method of claim 78, further comprising providing at least one of the pass code, the password, and the words to an authorized beneficiary through a transmission comprising at least one of: an Internet transmission, a wireless transmission, a radio transmission, a television transmission, an audible transmission, a visual transmission, a microwave transmission, a cellular transmission, a push-to-talk transmission, a digital transmission, and a combination thereof.

80. The method of claim 79, wherein the transmission is encrypted.

81. The method of claim 1, wherein the subscriptions comprise at least one of: time-limited rights of access; event-limited rights of access; inheritable rights of access; rights of access predicated upon a series of periodic payments; rights of access predicated upon a one-time payment; ownership-based rights of access; non-transferable rights of access; transferable rights of access; membership-based rights of access; fractionally-based rights of access; non-ownership-based rights of access; option-based rights of access, and a combination thereof.

82. The method of claim 1, wherein the civilly-catastrophic event comprises an event that substantially disrupts society's infrastructure and ability to provide at least one life-sustaining resource.

83. The method of claim 82, wherein the civilly-catastrophic event is one that persists in substantial form for more than a predetermined period of time.

84. The method of claim 82 wherein the civilly-catastrophic event comprises at least one of: a natural disaster; a non-natural disaster.

85. The method of claim 84, wherein the natural disaster comprises at least one of: a severe weather event; a severe geophysical event; a severe astronomical event; a severe disease-based event; a severe agricultural event; a severe natural shortage of a life-sustaining resource; and a combination thereof.

86. The method of claim 84, wherein the non-natural disaster comprises at least one of: warfare; an act of terrorism; an accident that results in public dispersal of a severe environmentally borne danger; an event that results in widespread exposure to a mutagenic danger; and a combination thereof.

87. A method comprising:
providing a plurality of private civil security resources comprising, at least in part: civil security provisions; civil security facilities; and civil security shuttle services; and
providing authorized beneficiaries with consideration-based access to a conveyance to provide the shuttle services between various ones of the civil security facilities respondent to a predetermined condition.

88. The method of claim 87, wherein the predetermined condition comprises at least one of: a predetermined duration; a predetermined facility capacity; a set interval; a random interval; a predetermined facility resource level; an inability of a facility to withstand a threat; a predetermined time; a predetermined day; a weather condition; a threat to a facility; a communication; a signal; a location of a facility; a terrain feature; one of a nature, attribute, character, or preference of an individual within a facility; a season; a threat to the conveyance; and a combination thereof.

89. The method of claim 87, wherein providing civil security facilities comprises providing:
a short-term civil security shelter arranged and configured to provide shelter for at least one authorized beneficiary for a first period of time;
an intermediate-term civil security shelter arranged and configured to provide shelter for at least one authorized beneficiary for a second period of time longer than the first period of time, and
a long-term civil security shelter arranged and configured to provide shelter for at least one authorized beneficiary for a third period of time longer than both the first and second periods of time.

90. The method of claim 89, wherein the conveyance shuttles the at least one authorized beneficiary from the short-term shelter to the intermediate-term shelter as a function, at least in part, of expiration of the first period of time.

91. The method of claim 90, wherein the conveyance shuttles the at least one authorized beneficiary from the intermediate-term shelter to the long-term shelter as a function, at least in part, of expiration of the second period of time.

92. The method of claim 91, wherein the short-term shelter is within a metropolitan area.

93. The method of claim 92, wherein the intermediate-term shelter is spaced a predetermined distance from the short-term shelter.

94. The method of claim 87, wherein providing civil security facilities comprises providing:
a first civil security shelter arranged and configured to withstand a civilly-catastrophic event of a first category; and
a second civil security shelter arranged and configured to withstand a civilly-catastrophic event of a second category having a greater intensity than the first category.

95. The method of claim 94, wherein the conveyance shuttles at least one authorized beneficiary from the first shelter to the second shelter as a function, at least in part, of the civilly-catastrophic event exceeding an ability of the first shelter to withstand the intensity thereof.

96. The method of claim 95, wherein the first shelter is within a metropolitan area.

97. The method of claim 96, wherein the second shelter is spaced a predetermined distance from the first shelter.

98. The method of claim 97, further comprising a third civil security shelter arranged and configured to withstand a civilly-catastrophic event of a third category having a greater intensity than both the first and the second category.

99. The method of claim 98, wherein the conveyance shuttles at least one authorized beneficiary from the second shelter to the third shelter as a function, at least in part, of the civilly-catastrophic event exceeding an ability of the second shelter to withstand the intensity thereof.

100. The method of claim 99, wherein the third shelter is spaced a predetermined distance from the second shelter.

101. A method comprising:
providing a first civil security shelter and a second civil security shelter;
accepting consideration-based private civil security subscriptions from subscribers with respect to providing civilly-catastrophic event-based access to the conveyance; and
shuttling at least one authorized beneficiary from the first shelter to the second shelter respondent to a predetermined condition.

102. The method of claim 101, further comprising providing a conveyance to shuttle the at least one authorized beneficiary from the first civil-security shelter to the second civil-security shelter.

103. The method of claim 102, wherein providing a conveyance comprises providing at least one of: an air-borne conveyance, a terrestrial conveyance, a water-bore conveyance, a subterranean conveyance, a space-based conveyance, a pilotless conveyance, a remotely piloted conveyance, a beast-of-burden, a guidance between the shelters, and a combination thereof.

104. The method of claim 101, further comprising providing a conveyance means to shuttle the at least one authorized beneficiary from the first civil-security shelter to the second civil-security shelter.

105. The method of claim 101, wherein the predetermined condition comprises at least one of: a predetermined duration; a predetermined facility capacity;
a set interval; a random interval; a predetermined facility resource level; an inability of a facility to withstand a threat; a predetermined time; a predetermined day; a weather condition; a threat to a facility; a communication; a signal; a location of a facility; a terrain feature; one of a nature, attribute, character, or preference of an individual within a facility; a season; a threat to the conveyance; and a combination thereof.

106. The method of claim 101, wherein shuttling the at least one authorized beneficiary from the first shelter to the second shelter comprises shuttling an authorized beneficiary along a predetermined route between the first shelter and the second shelter.

107. The method of claim 101, further comprising providing a third civil security shelter and shuttling at least one authorized beneficiary from the second civil security shelter to the third civil security shelter respondent to a predetermined condition.

108. The method of claim 102, wherein providing a first civil security shelter and a second civil security shelter comprises providing:
a first civil security shelter arranged and configured to withstand a civilly-catastrophic event of a first category; and
a second civil security shelter arranged and configured to withstand a civilly-catastrophic event of a second category having a greater intensity than the first category.

109. The method of claim 108, wherein the conveyance shuttles at least one authorized beneficiary from the first shelter to the second shelter as a function, at least in part, of the civilly-catastrophic event exceeding an ability of the first shelter to withstand the intensity thereof.

110. The method of claim 109, further comprising a third civil security shelter arranged and configured to withstand a civilly-catastrophic event of a third category having a greater intensity than both the first and the second category.

111. The method of claim 110, further comprising a plurality of conveyances and wherein one of the plurality of conveyances shuttles at least one authorized beneficiary from the second shelter to the third shelter as a function, at least in part, of the civilly-catastrophic event exceeding an ability of the second shelter to withstand the intensity thereof.
